(19) United States
(12) Patent Application Publication
(10) Pub. No.: US 2026/0169326 A1
(43) Pub. Date: Jun. 18, 2026

(54) DISPLAY SYSTEM AND VEHICLE TRIM ELEMENT COMPRISING SUCH A DISPLAY SYSTEM

(71) Applicant: Faurecia Clarion Electronics Europe, Paris (FR)

(72) Inventor: Edouard DA SILVA, PONTOISE (FR)

(21) Appl. No.: 19/418,351

(22) Filed: Dec. 12, 2025

(30) Foreign Application Priority Data
Dec. 12, 2024 (FR) FR 24 14011

(51) Int. Cl. G02F 1/1335; G09G 3/34; G09G 3/36

(52) U.S. Cl. CPC G02F 1/133526; G09G 3/3426; G09G 3/3648; G02F 2201/50; G09G 2320/068; G09G 2340/0407; G09G 2358/00; G09G 2380/10

(57) ABSTRACT

A display system that includes: a protective lens forming a display surface having a display area and at least one peripheral area, an electronic control unit, and a display device arranged opposite the display area, having a front face, facing the protective lens, configured to display a light signal on the display area, forming a first resolution display. The display system further includes at least one thin film extending between the protective lens and the front face of the display device, configured to guide light from a light source and to form light patterns, in response to a command from the electronic control unit, the light patterns forming a second-resolution display, lower than the first resolution, on the at least one peripheral area of the display surface.

### TECHNICAL FIELD

The present invention concerns a display system and a vehicle trim element comprising such a display system.

The invention is in the field of display systems more particularly suitable for integration in transport vehicles, especially motor vehicles.

### BACKGROUND

In particular, the invention applies in the field of display systems integrated into a trim element, and more particularly a vehicle trim element such as a dashboard, a central console, a seat, a door panel or other, intended to display information to the occupants of the vehicle, that is, passengers and driver, and/or audiovisual content (infotainment).

It is known to integrate a display device into a trim element, particularly for motor vehicles, comprising a liquid crystal or LCD (Liquid Crystal Display) screen, and a backlighting device for the screen in order to carry out a display of image data. In particular, Thin Film Transistor (TFT) technology is used to obtain good display quality.

In modern vehicles, large display surfaces are provided, these display surfaces being used to display images, information and visual animations for the various occupants of the vehicle, driver and passengers alike. In addition to displaying useful information, large display surfaces have a decorative role to play.

Nevertheless, the use of a TFT-LCD type display screen with high display resolution to achieve a large display area is costly. In a known manner, the display resolution is defined by the number of pixels per unit of length of the display surface.

It is known from FR3122616 B1 that a large display system, comprising a display area and one or more peripheral area(s), may be integrated into a trim element, provided with a light sheet extending partly opposite the peripheral area, in order to improve the visual continuity of the display area with the peripheral area.

### SUMMARY

An aim of the invention is to propose a display system with a large display surface, which is easier to implement and offers more functionalities than previously proposed solutions.

To this end, the invention relates to a display system comprising a protective lens forming a display surface, the display surface comprising a display area and at least one peripheral area, the display system comprising:
an electronic control unit, and
a display device arranged opposite the display area, comprising a front face, facing the protective lens, configured to display, in response to a command from the electronic control unit, a light signal on the display area, forming a first-resolution display.

This display system further comprises at least one thin film extending between the protective lens and the front face of the display device, configured to guide light from a light source and form light patterns, in response to a command from said electronic control unit, the light patterns forming a second-resolution display, lower than the first resolution, on the at least one peripheral area of the display surface.

Advantageously, the thin film can be used to create a decorative animation on at least one peripheral area.

According to other advantageous aspects of the invention, the display system comprises one or more of the following features, taken alone or in any technically feasible combination.

The at least one thin film also extends over the entire display area.

The system comprises at least two thin films, each thin film being configured to display distinct light patterns, modifiable by command from the electronic control unit.

The system comprises at least one thin film with an associated viewing angle, said thin film with an associated viewing angle being configured to form light patterns visible to a user positioned at a first spatial viewing position and opaque to a user positioned at a second spatial viewing position.

The display device is configured to switch on command from a public display mode to a private display mode and vice versa, the public display mode being a display mode in which the light signal displayed on the display area is visible from both the first spatial viewing position and the second spatial viewing position, the private display mode being a display mode in which the light signal displayed on the display area is visible from the first spatial viewing position but not visible from the second spatial viewing position, and said thin film having an associated viewing angle is configured to form, in response to a command to switch to the private display mode, light patterns visible to a user positioned at the second spatial viewing position, at least on said display area.

The system comprises a first thin film and a second thin film at least partially superimposed, each of said thin films having a distinct associated viewing angle, the first thin film being configured to form first light patterns visible to a user positioned at the first spatial viewing position and opaque to a user positioned at the second spatial viewing position, and the second thin film being configured to form second light patterns visible to a user positioned in the second spatial viewing position and opaque to a user positioned in the first spatial viewing position, each of the thin films being illuminated in response to a command to switch to a private display mode.

The display device is selected from a transmissive LCD, a reflective LCD, a transflective LCD and a self-emissive LCD.

The at least one thin film is illuminated via a lateral coupling element, which is configured to guide light from the light source to the thin film.

The at least one thin film is flexible and has a thickness of 0.5 mm or less.

The invention also relates to a motor vehicle trim element comprising a display system as described above.

### BRIEF DESCRIPTION OF THE DRAWINGS

The invention will become clearer on reading the following description, given solely by way of non-limiting example, and made with reference to the drawings, in which:

FIG. 1 is a representation of a display system according to a first embodiment.

FIG. 2 is a representation of a display system according to a second embodiment;

FIG. 3 is a view of a display surface of a display system, when the display device is in public display mode; and

FIG. 4 represents distinct views of the display surface according to the spatial viewing position, when the display device is in private display mode.

### DETAILED DESCRIPTION

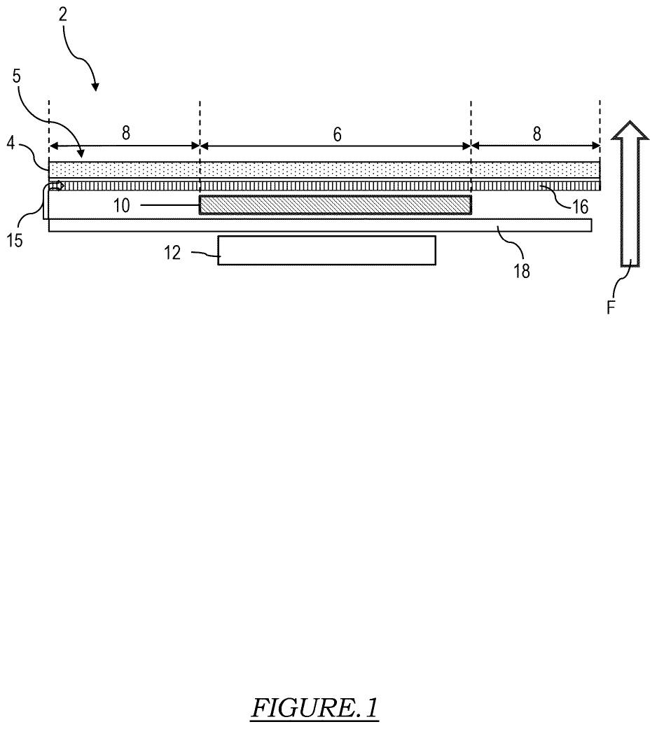

FIG. 1 shows schematically, in cross-section, elements of a display system 2, adapted to be integrated into a trim element of a vehicle, in particular a motor vehicle (not shown).

By “trim element” we mean, for example, a dashboard, center console, seat or door panel, or any other interior surface of the vehicle, or an exterior surface of the vehicle such as headlights or an exterior panel.

Display system 2 is used to display light signals, varying over time, forming information or multimedia content intended for passengers and/or driver inside the vehicle.

To this end, it comprises a protective lens 4 forming a display surface 5, visible to the passengers and driver, defining a display area 6 and a peripheral area 8 extending at least partially around the display area 6.

Display surface 5 is located at the front of display system 2, facing users, driver and passengers (not shown). When the display system 2 is installed in a vehicle, the display surface faces the interior of the vehicle.

In FIG. 1, the arrow F indicates the forward direction in display system 2.

The protective lens 4 serves to protect the display system 2, particularly from dirt, dust or mechanical shocks, while allowing users to see through it to the content provided by the display system 2.

For example, the protective lens is translucent. Translucent means that the light transmission rate is substantially between 5% and 100%, with a light transmission rate of less than 5% corresponding to an opaque part that does not let light through. In this way, the protective lens 4 allows light from the image display system 2 to pass through, so that this light is visible on the display surface.

The display system 2 further comprises a display device 10 and an electronic control unit 12.

The display device 10 is arranged opposite the display area 6, this display device 10 being configured to display, in response to an electronic command, a light signal on the display area 6, forming a first-resolution display.

The display device 10 comprises a backlight layer, in other words the light layer scatters a light signal towards the front of the lighting system; the direction of light scattering is indicated by the arrow F in FIG. 1.

In one embodiment, the light layer comprises a plurality of light-emitting diodes, for example arranged in an array of light-emitting diodes, the light-emitting diode array being electronically controlled by the electronic control unit 12.

As an alternative, the light-emitting diode array is formed by a plurality of subarrays of diodes which can be activated independently of one another and/or which can each emit a light signal identical to and/or different from the light signals emitted by the other subarrays according to the technology described in patent application FR3122615 B1. The integration of an array of light-emitting diodes enables time-variable shapes to be displayed on the display area.

In one embodiment, the display device 10 comprises a liquid crystal display (LCD), arranged opposite the display surface and backlit by the backlighting layer under control of the electronic control unit 12. The display device 10 is, for example, a TFT-LCD display device.

In another embodiment, the display device 10 is chosen from a transmissive, reflective, transflective or self-emissive LCD screen, with light-emitting diodes (LEDs) or organic light-emitting diodes (OLEDs).

The display system 2 further comprises a thin film 16 extending between the protective lens 4 and the front face of the display device 10, configured to guide light from a light source 18 and to form patterns on at least the at least one peripheral area 8, in response to a command from the electronic control unit 12.

For example, light source 18 comprises one or more light-emitting diodes.

By thin film we mean a flexible film with a thickness of less than or equal to 0.5 mm, preferably between 0.03 mm and 0.2 mm. By way of example, thin film 18 is a transparent plastic film, for example made of optical-grade polycarbonate (PC) or polymethyl methacrylate (PMMA).

In one embodiment, the thin film 16 extends over the entire surface of the protective lens 4 but comprises a transparent area facing the display area 6, and nano-perforations or nanoforms (prismatic or lenticular type) forming transparent areas and opaque areas, facing at least one peripheral area 8.

Alternatively, thin film 16 can extend opposite one or more peripheral areas without extending opposite the display surface.

According to another variant, the thin film 16 extends at least partially opposite the display area 6, or extends over the entire display area, and opposite at least one peripheral area 8, and comprises nano-perforations over its entire surface.

Preferably, when the display device 10 has opaque technical edges (“bezel area”), the thin film 16 extends over the technical edges. The technical edges are inherent to the technical implementation of the display device 10 and do not allow information to be displayed; these are “dead” areas. When the thin film 16 extends over the technical edges, this advantageously animates these technical edges visually and creates a large display surface without dead areas, with visual continuity for the user.

The thin film 16 is illuminated via a lateral coupling element 15, which is configured to guide light from the light source 18 to the thin film 16. The lateral coupling element 15 is, for example, of the same material as the thin film 16, and preferably extends between an edge of the thin film 16 and the light source 18.

The electronic control unit 12 is configured to control the intensity and/or wavelength of the light source 18, enabling light patterns to be created on the peripheral surface(s); these light patterns can evolve over time.

Advantageously, thin film 16 can be used to create light patterns when illuminated, particularly on the peripheral area(s) opposite the ones it extends.

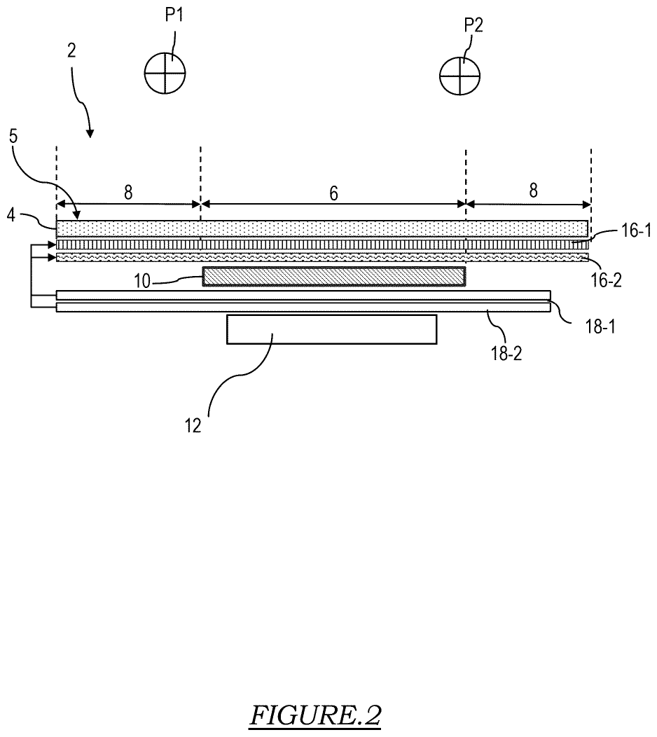

In a second embodiment shown with reference to FIG. 2, the display system 2, seen in cross-section, comprises two thin films 16-1, 16-2, at least partially superimposed, of the same type as the thin film 16 described with reference to FIG. 1, the illumination of each of the thin films 16-1, 16-2 being independently controllable. Each of the thin films 16-1, 16-2 comprises nano-perforations or nanoforms (prismatic or lenticular type), enabling distinct light patterns to be formed on command, respectively from the first light patterns formed by the first thin film 16-1, and from the second light patterns formed by the second thin film 16-2.

For example, the two thin films 16-1, 16-2 are superimposed and have the same surface area, with the first thin film 16-1 arranged between the second thin film 16-2 and the protective lens 4, the second thin film 16-2 being arranged above the screen of the display device 10.

According to variants, other thin-film layers of the type described above are integrated into the display system 2, in order to provide more contextuality and surface luminous animation

In a particular embodiment, each of the thin films 16-1, 16-2 forms a light guide with an associated viewing angle, whose displayed light patterns are visible or opaque depending on the user's spatial position, hereinafter referred to as the spatial viewing position.

So, for example, first light patterns emitted by the first thin film 16-1 when illuminated by the first light source 18-1 are visible to a user placed in the first spatial viewing position P1 and are opaque to a user placed in the second spatial viewing position P2, and second light patterns emitted by the second thin film 16-2 when illuminated by the second light source 18-2 are visible to a user placed in the second spatial viewing position P2 and are opaque to a user placed in the first spatial viewing position P1.

For example, in a motor vehicle, the first spatial viewing position P1 is associated with the driver's seat of the motor vehicle and the second spatial viewing position P2 is associated with the front passenger seat of the vehicle, or vice versa.

When the display system comprises respectively a first thin film 16-1 and a second thin film 16-2, each with a distinct associated viewing angle, it is envisaged to control the simultaneous illumination of both thin films 16-1 and 16-2, so as to create distinct light patterns visible from distinct spatial viewing positions.

In this way, for example, the driver and front passenger of a motor vehicle do not see the same light patterns on the peripheral areas of the display surface, but each nevertheless sees a display surface comprising the display area 6 of the light signal from the display device 10 and light patterns on the peripheral areas, so each sees a large display surface.

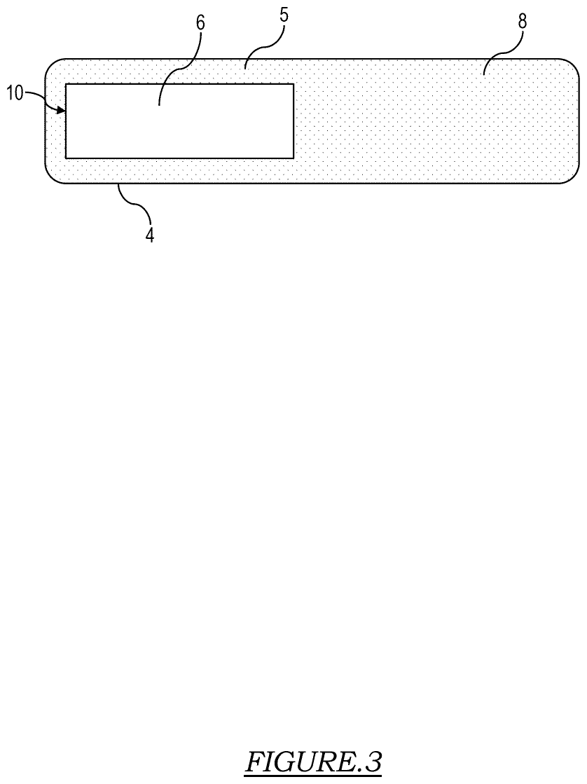

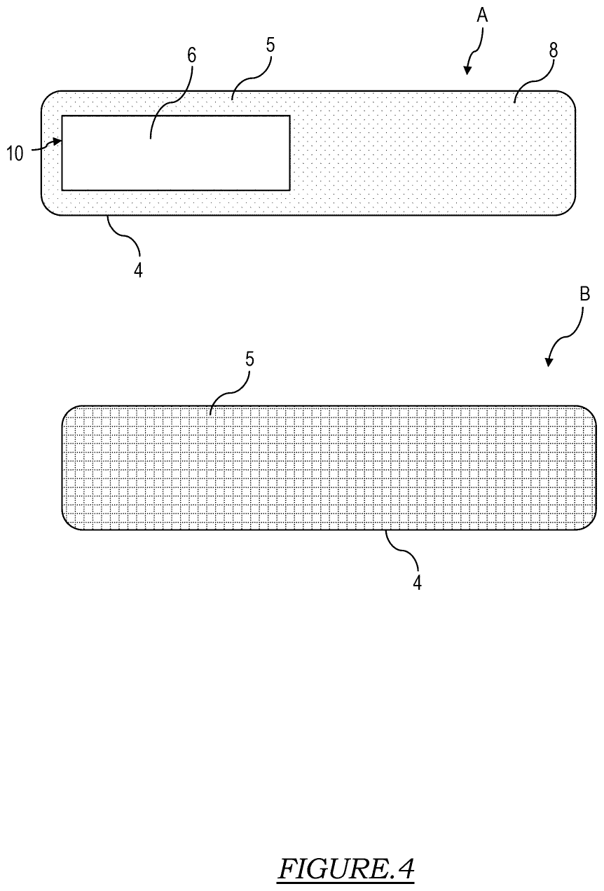

In an embodiment described more specifically with reference to FIGS. 3 and 4, the display device 10, for example a TFT-LCD screen, is equipped with a switchable privacy feature that can be activated by the user.

The display device 10 then comprises a public display mode, in which the light signal displayed on the display screen is visible from any viewing angle, in particular visible from the first spatial viewing position P1 and from the second spatial viewing position P2. The display device 10 also includes a private or confidential display mode, in which the light signal displayed on the screen is visible from the first spatial viewing position P1 and not visible from the second spatial viewing position P2. The user can control the switching from private display mode to public display mode and vice versa.

FIG. 3 schematically shows the public display mode of a display system 2. In the example shown, the display area 6 is off-center with respect to the display surface 5. The display area 6 is positioned opposite the first spatial viewing position P1, for example the spatial position of the front passenger of a motor vehicle. The peripheral area 8 extends over the remainder of the display surface 5.

In public display mode, each of the users (for example driver, passenger) located respectively at the first spatial viewing position P1 and the second spatial viewing position P2, sees the entire display surface, including the light signal displayed on display area 6 (infotainment content) and the light patterns displayed on peripheral area 8.

Advantageously, in private display mode, and as shown in FIG. 4, the display system 2 is configured to activate the thin films 16-1, 16-2 with associated viewing angles so that the user located in the first spatial viewing position P1 retains the vision of the public display mode (insert A in FIG. 4), while the user located in the second spatial viewing position P2 views the second light patterns produced by the second thin film 16-2 over the entire display surface 5 (insert B in FIG. 4).

Advantageously, the electronic control unit 12 is configured so as, on receiving a command to switch to private display mode on the display device 10, to control at least one illumination of the second thin film 16-2, which scatters light patterns over at least the display area, and preferably over the entire display surface.

As an optional extra, the illumination of the first thin film 16-1 is also controlled at approximately the same time so as to activate a decorative animation in the peripheral area surrounding the display area 6, intended for the user positioned in the first spatial viewing position P1.

Preferably, the electronic control unit 12 controls the illumination of the first thin film 16-1 to effect colored illumination, with the display colors dynamically evolving in harmony with the content displayed on the display area 6.

Thus, advantageously, when the display system 2 comprises two thin films 16-1, 16-2 with associated viewing angles and a display device 10 equipped with a switchable privacy functionality, the display system 2 is configured to display, substantially synchronized with the switchover to private display mode, by activation of the first and second thin films, first patterns visible to the user placed in the first spatial viewing position P1 and second patterns to the user placed in the second spatial viewing position P2. As a result, each user benefits from an enhanced experience.

When the display system 2 comprises a single thin film 16 with associated viewing angle and a display device 10, placed opposite the first spatial viewing position and provided with a switchable privacy functionality, the display system 2 is configured to display, substantially synchronously with the switchover to private display mode, by activating the thin film illumination, light patterns visible to the user placed in the second spatial viewing position P2. Thus, when the private display mode is activated, the user in front of the display device 10 continues to see the displayed content, and the other user sees the light patterns emitted by the illuminated thin film.

For example, in one application, the first spatial viewing position P1 corresponds to the vehicle's front passenger and the second spatial viewing position P2 corresponds to the driver. The proposed display system allows the front passenger to view multimedia content (for example a film or video game) on a screen positioned opposite his or her seat, displayed in the display area, while hiding this content from the driver in private display mode. The driver, without being disturbed by the scrolling of the displayed content, nevertheless sees light patterns. Advantageously, instead of a dark “dead area”, the driver can view the light patterns over the entire display surface, including the display area facing the passenger.

The invention has been described above for a display system comprising one display area and one or more peripheral areas.

Clearly, the invention applies analogously to a plurality of display areas and a plurality of peripheral areas.

For example, it is possible to form one or more display areas opposite each of the spatial viewing positions, for example a “driver” display area and a “passenger” display area, each of the display areas being illuminated by a corresponding display device. In this case, the display system is configured to manage the switching to private display mode of each display device, opposite one of the spatial viewing positions, and the display of light patterns visible from the other spatial viewing position.

1. A display system comprising a protective lens forming a display surface, the display surface having a display area and at least one peripheral area, the display system comprising:
an electronic control unit, and
a display device arranged opposite the display area, comprising a front face facing the protective lens, configured to display, in response to a command from the electronic control unit, a light signal on the display area, forming a first-resolution display,
wherein the display system further comprises at least one thin film extending between the protective lens and the front face of the display device, configured to guide light from a light source and to form light patterns, in response to a command from said electronic control unit, the light patterns forming a display of second resolution, lower than the first resolution, on the at least one peripheral area of the display surface.

2. The display system according to claim 1, wherein said at least one thin film also extends over the entire display area.

3. The display system according to claim 1, comprising at least two thin films, each thin film being configured to display distinct light patterns, modifiable by command from the electronic control unit.

4. The display system according to claim 1, comprising at least one thin film having an associated viewing angle, said thin film with associated viewing angle being configured to form light patterns visible to a user positioned at a first spatial viewing position and opaque to a user positioned at a second spatial viewing position.

5. The display system according to claim 4, wherein said display device is configured to switchover on command from a public display mode to a private display mode and vice versa, the public display mode being a display mode in which the light signal displayed on the display area is visible from both the first spatial viewing position and the second spatial viewing position, the private display mode being a display mode in which the light signal displayed on the display area is visible from the first spatial viewing position but not visible from the second spatial viewing position,
and wherein said thin film having an associated viewing angle is configured to form, in response to a command to switch to the private display mode, light patterns visible to a user placed at the second spatial viewing position, at least on said display area.

6. The display system according to claim 4, comprising a first thin film and a second thin film at least partially superimposed, each of said thin films having a distinct associated viewing angle, the first thin film being configured to form first light patterns visible to a user placed at the first spatial viewing position and opaque to a user placed at the second spatial viewing position, and the second thin film being configured to form second light patterns visible to a user placed in the second spatial viewing position and opaque to a user placed in the first spatial viewing position, each of the thin films being illuminated in response to a command to switch to a private display mode.

7. The display system according to claim 1, wherein said display device is selected from a transmissive LCD, a reflective LCD, a transflective LCD, a self-emissive LCD.

8. The display system according to claim 1, wherein said at least one thin film is illuminated via a lateral coupling element, which is configured to guide light from the light source to the thin film.

9. The display system according to claim 1, wherein said at least one thin film is flexible and has a thickness less than or equal to 0.5 millimeters.

10. A trim element for a motor vehicle comprising the display system according to claim 1.
